(19) United States
(12) Patent Application Publication
(10) Pub. No.: US 2026/0341548 A1
(43) Pub. Date: Oct. 29, 2026

(54) SYSTEMS AND METHODS FOR STORING AND MONITORING HAZARDOUS WASTE

(71) Applicant: Deep Isolation, Inc., Berkeley, CA (US)

(72) Inventor: Richard A. Muller, Berkeley, CA (US)

(21) Appl. No.: 19/113,608

(22) PCT Filed: Oct. 10, 2023
(86) PCT No.: PCT/US2023/034812

§ 371 Date: Mar. 20, 2025

Related U.S. Application Data
(60) Provisional application No. 63/414,019, filed on Oct. 7, 2022.
(60) Provisional application No. 63/414,025, filed on Oct. 7, 2022.
(60) Provisional application No. 63/415,703, filed on Oct. 13, 2022.

(51) Int. Cl. G21F 9/24; B09B 1/00; E21B 41/00; E21B 47/00; G21F 9/34

(52) U.S. Cl. CPC G21F 9/24; B09B 1/008; E21B 41/005; E21B 47/006; G21F 9/34

(57) ABSTRACT

A hazardous waste repository includes a directional drillhole formed from a terranean surface into a subterranean formation. The directional drillhole includes an access drillhole portion that includes an entry at the terranean surface sized to receive one or more hazardous waste canisters configured to enclose hazardous waste, a curved drillhole portion, and a substantially horizontal or inclined drillhole portion. The substantially horizontal or inclined drillhole portion includes a storage region sized and configured to store the one or more hazardous waste canisters. The repository includes a flow conduit formed or installed from the terranean surface into the subterranean formation and in fluid communication with the storage region. The flow conduit and the directional drillhole are configured to receive a flow of a liquid that circulates from the terranean surface, through the flow conduit and the storage region, and back to the terranean surface for a corrosion analysis of the liquid.

### TECHNICAL FIELD

This disclosure relates to systems and methods for storing and monitoring hazardous waste and, more particularly, storing and monitoring radioactive waste stored in a drillhole formed in a subterranean formation.

### BACKGROUND

Hazardous waste is often placed in long-term, permanent, or semi-permanent storage so as to prevent health issues among a population living near the stored waste. Such hazardous waste storage is often challenging, for example, in terms of storage location identification and surety of containment. For instance, the safe storage of nuclear waste (e.g., spent nuclear fuel, whether from commercial power reactors, test reactors, or even military waste) is considered to be one of the outstanding challenges of energy technology. Safe storage of the long-lived radioactive waste is a major impediment to the adoption of nuclear power in the United States and around the world. Conventional waste storage methods have emphasized the use of tunnels and is exemplified by the design of the Yucca Mountain storage facility. Other techniques include boreholes, including vertical boreholes, drilled into crystalline basement rock. Other conventional techniques include forming a tunnel with boreholes emanating from the walls of the tunnel in shallow formations to allow human access.

### SUMMARY

In an example implementation, a hazardous waste repository includes a directional drillhole formed from a terranean surface into a subterranean formation. The directional drillhole includes an access drillhole portion that includes an entry at the terranean surface sized to receive one or more hazardous waste canisters configured to enclose hazardous waste, a curved drillhole portion coupled to the access drillhole portion, and a substantially horizontal or inclined drillhole portion coupled to the curved drillhole portion. The substantially horizontal or inclined drillhole portion includes a storage region sized and configured to store the one or more hazardous waste canisters. The repository includes a flow conduit formed or installed from the terranean surface into the subterranean formation and in fluid communication with the storage region. The flow conduit and the directional drillhole are configured to receive a flow of a liquid that circulates from the terranean surface, through the flow conduit and the storage region, and back to the terranean surface for a corrosion analysis of the liquid.

In an aspect combinable with the example implementation, the flow conduit and the directional drillhole are configured to receive the flow of the liquid that circulates from the terranean surface, through the flow conduit, into the storage region from the flow conduit, and back to the terranean surface from the storage region for the corrosion analysis of the liquid.

In another aspect combinable with any of the previous aspects, the corrosion analysis of the liquid includes an analysis of one or more metallic particles within the liquid from one or both of a casing installed in the directional drillhole or the one or more hazardous waste canisters.

In another aspect combinable with any of the previous aspects, the corrosion analysis of the liquid includes an analysis of an origin of the one or more metallic particles based on a type of metal of the one or more metallic particles.

In another aspect combinable with any of the previous aspects, the flow conduit includes a borehole formed from the terranean surface into the subterranean formation to intersect the directional drillhole.

In another aspect combinable with any of the previous aspects, the borehole includes a substantially vertical borehole.

In another aspect combinable with any of the previous aspects, the borehole includes a slant or directional borehole.

In another aspect combinable with any of the previous aspects, a diameter of the borehole is smaller than a diameter of the storage region.

In another aspect combinable with any of the previous aspects, the borehole intersects the storage region.

In another aspect combinable with any of the previous aspects, the flow conduit includes a pilot hole that extends from the directional drillhole and includes an opening at the terranean surface separate from the entry.

In another aspect combinable with any of the previous aspects, the pilot hole includes a diameter that is the same as or substantially similar to a diameter of the storage region.

In another aspect combinable with any of the previous aspects, the pilot hole includes another storage region sized and configured to store another one or more hazardous waste canisters.

In another aspect combinable with any of the previous aspects, the flow conduit includes a catheter installed on or in the casing, the catheter including a hollow tube having a first open end at or near the terranean surface and a second open end in the directional drillhole.

In another aspect combinable with any of the previous aspects, the second open end is positioned in the storage region.

In another aspect combinable with any of the previous aspects, the hollow tube is attached to an exterior surface of the casing.

In another aspect combinable with any of the previous aspects, the catheter is installed on or in the casing prior to installation of the casing in the directional drillhole.

In another aspect combinable with any of the previous aspects, the hazardous waste includes nuclear waste.

In another example implementation, a method for monitoring hazardous waste in a hazardous waste repository includes identifying a directional drillhole formed from a terranean surface into a subterranean formation. The directional drillhole includes an access drillhole portion that includes an entry at the terranean surface, a curved drillhole portion coupled to the access drillhole portion, and a substantially horizontal or inclined drillhole portion coupled to the curved drillhole portion that includes a storage region that stores one or more hazardous waste canisters configured to enclose hazardous waste. The method includes identifying a flow conduit formed or installed from the terranean surface into the subterranean formation and in fluid communication with the storage region. The flow conduit and the directional drillhole form a liquid flow path to and from the terranean surface. The method includes circulating a liquid from the terranean surface, through the liquid flow path, and back to the terranean surface; and performing a corrosion analysis of the liquid circulated back to the terranean surface from the liquid flow path.

In an aspect combinable with the example implementation, circulating the liquid from the terranean surface, through the liquid flow path, and back to the terranean surface includes flowing the liquid from the terranean surface, through the flow conduit, into the storage region from the flow conduit, and back to the terranean surface from the storage region.

In another aspect combinable with any of the previous aspects, performing the corrosion analysis includes performing the corrosion analysis of one or more metallic particles within the liquid from one or both of a casing installed in the directional drillhole or the one or more hazardous waste canisters.

In another aspect combinable with any of the previous aspects, the corrosion analysis of the liquid includes an analysis of an origin of the one or more metallic particles based on a type of metal of the one or more metallic particles.

In another aspect combinable with any of the previous aspects, the flow conduit includes a borehole formed from the terranean surface into the subterranean formation to intersect the directional drillhole.

In another aspect combinable with any of the previous aspects, the borehole includes a substantially vertical borehole.

In another aspect combinable with any of the previous aspects, the borehole includes a slant or directional borehole.

In another aspect combinable with any of the previous aspects, a diameter of the borehole is smaller than a diameter of the storage region.

In another aspect combinable with any of the previous aspects, the borehole intersects the storage region.

In another aspect combinable with any of the previous aspects, the flow conduit includes a pilot hole that extends from the directional drillhole and includes an opening at the terranean surface separate from the entry.

In another aspect combinable with any of the previous aspects, the pilot hole includes a diameter that is the same as or substantially similar to a diameter of the storage region.

In another aspect combinable with any of the previous aspects, the pilot hole includes another storage region sized and configured to store another one or more hazardous waste canisters.

In another aspect combinable with any of the previous aspects, the flow conduit includes a catheter installed on or in the casing, the catheter including a hollow tube having a first open end at or near the terranean surface and a second open end in the directional drillhole.

In another aspect combinable with any of the previous aspects, the second open end is positioned in the storage region.

In another aspect combinable with any of the previous aspects, the hollow tube is attached to an exterior surface of the casing.

In another aspect combinable with any of the previous aspects, the catheter is installed on or in the casing prior to installation of the casing in the directional drillhole.

In another aspect combinable with any of the previous aspects, the hazardous waste includes nuclear waste.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a schematic illustration of an example implementation of a hazardous waste repository that includes a waste monitoring system according to the present disclosure.

FIG. 1B is a schematic illustration of another example implementation of a hazardous waste repository that includes a waste monitoring system according to the present disclosure.

FIG. 2 is a schematic illustration of an example implementation of a hazardous waste repository according to the present disclosure.

FIG. 3A is a schematic illustration of another example implementation of a hazardous waste repository that includes a waste monitoring system that includes fiber optic scintillators according to the present disclosure.

FIG. 3B is a table that illustrates an example implementation of a coding system used to identify hazardous waste canister by scintillator location according to the present disclosure.

FIG. 3C is a schematic illustration of an example implementation of a fiber optic cable that includes multiple fibers with scintillators for detecting radiation in the waste monitoring system of FIG. 3A.

FIG. 4 is a schematic illustration of a controller or control system for monitoring a hazardous waste repository according to the present disclosure.

### DETAILED DESCRIPTION

Hazardous waste, such as radioactive waste, chemical waste, biologic waste, or other waste that is generally harmful to living creatures whether directly or indirectly, can be stored underground in a hazardous waste repository formed in a drillhole (e.g., borehole, wellbore). As an example, radioactive waste (also referred to as nuclear waste, such as spent nuclear fuel, TRansUranic waste, high level waste, and other nuclear waste) can be stored in deep, human-unoccupiable drillholes that are formed from a terranean surface into one or more subterranean formations that are suitable to store such waste for years, decades, centuries, or longer. For instance, the human-unoccupiable drillholes can be directional drillholes formed with conventional drilling equipment and include vertical, curved, and horizontal portions (including multilaterals in some cases). Alternatively, the human-unoccupiable drillholes can be substantially vertical or slanted (e.g., formed offset from substantially vertical).

The hazardous waste can be enclosed in hazardous waste canisters that are then sealed and moved into the drillhole for temporary or permanent emplacement in the repository. Often, the repository is formed in a substantially horizontal portion of the drillhole, and multiple canisters can be emplaced. There can be an advantage to storing the hazardous waste (in the canisters) within the drillhole for a period of months to years to decades, and only when a later decision is made that the waste should be “disposed,” (i.e., permanently), then taking additional steps to do so. In some aspects, for a drillhole repository, the additional steps could include simple procedures, such as sealing a section of the drillhole (e.g., a vertical section) to prevent any flow of waste (or liquid that contains waste) up to the terranean surface within the directional drillhole.

Although conventional thinking is that, once emplaced, the hazardous waste canisters should remain there permanently with no further action to monitor the canisters or ensure irretrievability of the canisters (if desired or necessary), such thinking can be disadvantageous. During a storage time period (e.g., prior to a decision being made for permanent disposal), additional work can be done to evaluate if sealing the drillhole offers a sufficiently safe and reliable long-term disposal solution. Thus, an example hazardous waste repository can include a temporary storage solution with an option of permanent disposal (with few additional steps taken). However, such a solution may need assurances that the hazardous waste can be retrieved if a determination is made that the repository is deemed unacceptable for permanent disposal.

Example impediments to retrieval of hazardous waste canisters in a drillhole repository include corrosion of a casing (e.g., a tubular string of threaded or otherwise connected casing joints installed in the drillhole) and/or of the canisters that contain the hazardous waste. Robust latching mechanisms can assure that a connection could be made between a retrieval cable and the canisters, but if the canister is damaged by corrosion or if the casing is so damaged that the canister cannot be safely pulled back out to the surface then the ability to retrieve the hazardous waste can be lost.

The present disclosure describes systems and methods for monitoring hazardous waste that is stored in a drillhole repository and, more particularly, monitoring one or more conditions in the drillhole that can be indicative of a presence of corrosion in the drillhole. For instance, in some aspects, an advantageous way to assure that corrosion is and remains low is to monitor the drillhole for as long as the storage option (rather than permanent disposal) is still in effect. However, such monitoring is not convenient and presents technical challenges. For example, a hazardous waste repository can include a substantially vertical access drillhole portion that then curves (with a radius portion) into a substantially horizontal (or inclined) drillhole portion. At least a portion of the substantially horizontal (or inclined) drillhole portion includes a storage region or area in which the hazardous waste canisters can be emplaced. The depth (e.g., TVD) of the storage region can be, e.g., 1.5 km under the terranean surface and filled with the hazardous waste canisters (each about 4 meters long, with perhaps 1 meter spacing there between). The canisters could sit on an interior surface of the casing (e.g., at the bottom of the storage region) or they could be offset from the interior surface by spacers. The volume of the storage region that is not occupied by canisters can filled with a fluid (e.g., naturally or otherwise), typically a brine, but possibly containing corrosion-resistant chemicals. Such an environment cannot be easily monitored for corrosion.

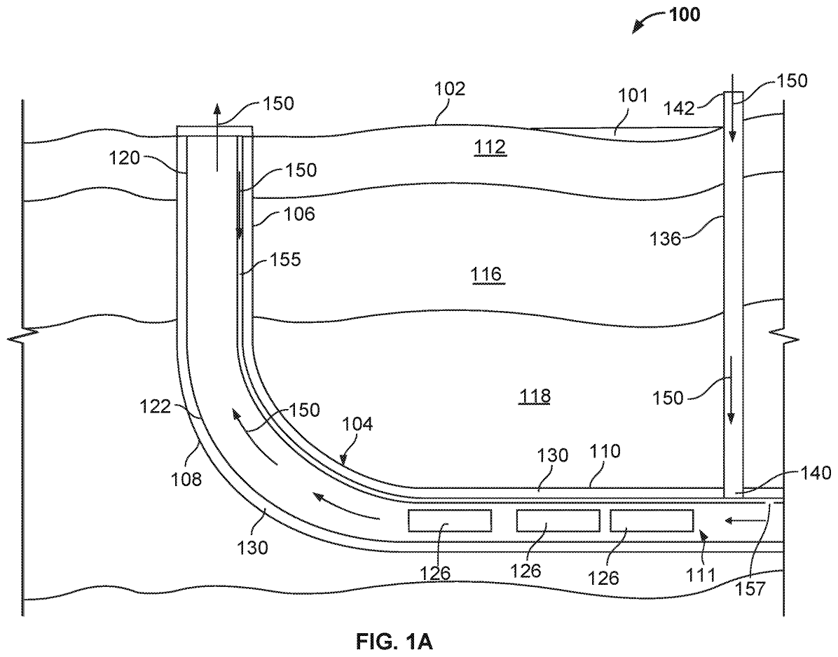

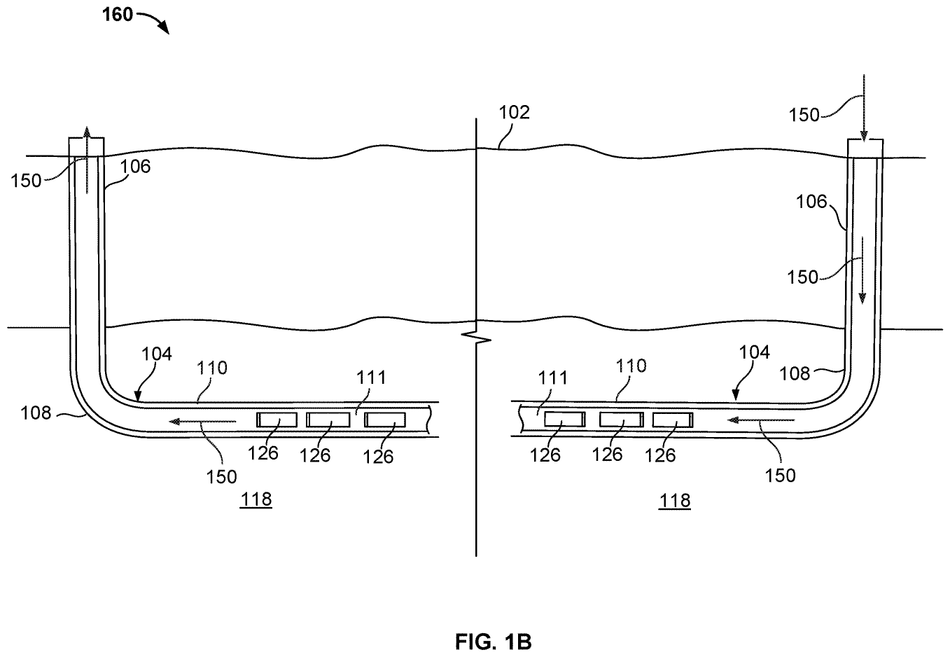

FIG. 1A is a schematic illustration of an example implementation of a hazardous waste repository 100 that includes a waste monitoring system according to the present disclosure. Turning to FIG. 1A, this figure illustrates an example hazardous waste repository 100 subsequent to the emplacement of one or more hazardous waste canister 126 and during a monitoring operation with a waste monitoring system. As illustrated, the hazardous waste repository 100 includes a drillhole 104 formed (e.g., drilled or otherwise) from a terranean surface 102 and through multiple subterranean layers 112, 116, and 118. Although the terranean surface 102 is illustrated as a land surface, terranean surface 102 may be a sub-sea or other underwater surface, such as a lake or an ocean floor or other surface under a body of water 101. Thus, the present disclosure contemplates that the drillhole 104 may be formed under a body of water 101 from a drilling location on or proximate the body of water 101.

The illustrated drillhole 104 is a directional drillhole in this example of hazardous waste repository 100. For instance, the drillhole 104 includes a substantially vertical portion 106 coupled to a radiussed or curved portion 108, which in turn is coupled to a substantially horizontal portion 110. As used in the present disclosure, “substantially” in the context of a drillhole orientation, refers to drillholes that may not be exactly vertical (e.g., exactly perpendicular to the terranean surface 102) or exactly horizontal (e.g., exactly parallel to the terranean surface 102). In other words, those of ordinary skill in the drill arts would recognize that vertical drillholes often undulate offset from a true vertical direction, that they might be drilled at an angle that deviates from true vertical, and horizontal drillholes often undulate offset from a true horizontal direction. Further, the substantially horizontal portion 110, in some aspects, may be a slant drillhole or other directional drillhole that is oriented between exactly vertical and exactly horizontal. Further, the substantially horizontal portion 110, in some aspects, may be a slant drillhole or other directional well bore that is oriented to follow the slant of the formation. As illustrated in this example, the three portions of the drillhole 104—the vertical portion 106, the radiussed portion 108, and the horizontal portion 110—form a continuous drillhole 104 that extends into the Earth. A storage region 111 of, in this example, the horizontal portion 110 of the directional drillhole 104.

The illustrated drillhole 104 has a surface casing 120 positioned and set around the drillhole 104 from the terranean surface 102 into a particular depth in the Earth. For example, the surface casing 120 may be a relatively large-diameter tubular member (or string of members) set (e.g., cemented) around the drillhole 104 in a shallow formation. As used herein, “tubular” may refer to a member that has a circular cross-section, elliptical cross-section, or other shaped cross-section. For example, in this implementation of the hazardous waste repository 100, the surface casing 120 extends from the terranean surface through a surface layer 112. The surface layer 112, in this example, is a geologic layer comprised of one or more layered rock formations. In some aspects, the surface layer 112 in this example may or may not include freshwater aquifers, salt water or brine sources, or other sources of mobile water (e.g., water that moves through a geologic formation). In some aspects, the surface casing 112 may isolate the drillhole 104 from such mobile water, and may also provide a hanging location for other casing strings to be installed in the drillhole 104. Further, although not shown, a conductor casing may be set above the surface casing 112 (e.g., between the surface casing 112 and the surface 102 and within the surface layer 112) to prevent drilling fluids from escaping into the surface layer 112.

As illustrated, a production casing 122 is positioned and set within the drillhole 104 downhole of the surface casing 120. Although termed a “production” casing, in this example, the casing 122 may or may not have been subject to hydrocarbon production operations. Thus, the casing 122 refers to and includes any form of tubular member that is set (e.g., cemented) in the drillhole 104 downhole of the surface casing 120. In some examples of the hazardous waste repository 100, the production casing 122 may begin at an end of the radiussed portion 108 and extend throughout the substantially horizontal portion 110. The casing 122 could also extend into the radiussed portion 108 and into the vertical portion 106.

As shown, cement 130 is positioned (e.g., pumped) around the casings 120 and 122 in an annulus between the casings 120 and 122 and the drillhole 104. The cement 130, for example, may secure the casings 120 and 122 (and any other casings or liners of the drillhole 104) through the subterranean layers under the terranean surface 102. In some aspects, the cement 130 may be installed along the entire length of the casings (e.g., casings 120 and 122 and any other casings), or the cement 130 could be used along certain portions of the casings if adequate for a particular drillhole 104. The cement 130 can also provide an additional layer of confinement for the hazardous material in canisters 126.

The drillhole 104 and associated casings 120 and 122 may be formed with various example dimensions and at various example depths (e.g., true vertical depth, or TVD). For instance, a conductor casing (not shown) may extend down to about 120 feet TVD, with a diameter of between about 28 in. and 60 in. The surface casing 120 may extend down to about 2500 feet TVD, with a diameter of between about 22 in. and 48 in. An intermediate casing (not shown) between the surface casing 120 and production casing 122 may extend down to about 8000 feet TVD, with a diameter of between about 16 in. and 36 in. The production casing 122 may extend substantially horizontally (e.g., to case the substantially horizontal portion 110) with a diameter of between about 11 in. and 22 in. The foregoing dimensions are merely provided as examples and other dimensions (e.g., diameters, TVDs, lengths) are contemplated by the present disclosure. For example, diameters and TVDs may depend on the particular geological composition of one or more of the multiple subterranean layers (112, 116, 118), particular drilling techniques, as well as a size, shape, or design of a hazardous material canister 126 that contains hazardous material to be deposited in the hazardous waste repository 100. In some alternative examples, the production casing 122 (or other casing in the drillhole 104) could be circular in cross-section, elliptical in cross-section, or some other shape.

As illustrated, the drillhole 104 extends through subterranean layers 112 and 116 and lands in subterranean layer 118. As discussed above, the surface layer 112 may or may not include mobile water. Other subterranean layers between layers 112 and 118 can also include sources of mobile water, such as freshwater aquifers, salt water or brine, or other source of mobile water. In this example of hazardous waste repository 100, mobile water may be water that moves through a subterranean layer based on a pressure differential across all or a part of the subterranean layer. In this example, there can be an impermeable layer 116. The impermeable layer 116, in this example, may not allow mobile water to pass through. The impermeable layer 116 may have low permeability, e.g., on the order of nanodarcy permeability. Additionally, in this example, the impermeable layer 116 may be a relatively non-ductile (i.e., brittle) geologic formation. One measure of non-ductility is brittleness, which is the ratio of compressive stress to tensile strength. In some examples, the brittleness of the impermeable layer 116 may be between about 20 MPa and 40 MPa.

As shown in this example, the impermeable layer 116 is shallower (e.g., closer to the terranean surface 102) than the storage layer 118. In this example rock formations of which the impermeable layer 116 may be composed include, for example, certain kinds of sandstone, mudstone, clay, and slate that exhibit permeability and brittleness properties as described above. In alternative examples, the impermeable layer 116 may be deeper (e.g., further from the terranean surface 102) than the storage layer 118. In such alternative examples, the impermeable layer 116 may be composed of an igneous rock, such as granite.

The storage layer 118, in this example, may be chosen as the landing for the substantially horizontal portion 110, which stores the hazardous material, for several reasons. Relative to the impermeable layer 116 or other layers, the storage layer 118 may be thick, e.g., between about 100 and 200 feet of total vertical thickness. Thickness of the storage layer 118 may allow for easier landing and directional drilling, thereby allowing the substantially horizontal portion 110 to be readily emplaced within the storage layer 118 during constructions (e.g., drilling). If formed through an approximate horizontal center of the storage layer 118, the substantially horizontal portion 110 may be surrounded by about 50 to 100 feet of the geologic formation that comprises the storage layer 118. Further, the storage layer 118 may also have no mobile water, e.g., due to a very low permeability of the layer 118 (e.g., on the order of milli-or nanodarcys). In addition, the storage layer 118 may have sufficient ductility, such that a brittleness of the rock formation that comprises the layer 118 is between about 3 MPa and 10 MPa. Examples of rock formations of which the storage layer 118 may be composed include: shale and anhydrite. Further, in some aspects, hazardous material may be stored below the storage layer, even in a permeable formation such as sandstone or limestone, if the storage layer is of sufficient geologic properties to isolate the permeable layer from a mobile water layer. In some examples implementations of the hazardous waste repository 100, the storage layer 118 is composed of shale, salt, or other geologic formation.

The present disclosure contemplates that there may be many other layers between or among the illustrated subterranean layers 112, 116, and 118. For example, there may be repeating patterns (e.g., vertically), of one or more of the layers. Further, in some instances, the storage layer 118 may be directly adjacent (e.g., vertically) a mobile water layer, i.e., without an intervening impermeable layer 116.

FIG. 1A shows an example waste monitoring system for a hazardous waste repository that, for example, monitors a fluid circulated through the storage region 111 and, in some aspects, the entire drillhole 104, to detect corrosion (through analysis of the fluid) of one or more components of the repository 100, such as one or more casings or one or more of the hazardous waste canisters 126. According to this example implementation, the waste monitoring system includes a flow conduit that is formed or installed from the terranean surface to fluidly connect to the storage region. A fluid 150 (e.g., liquid), such as a brine, can be circulated (e.g., periodically or continuously, by a pumping system (not shown)) from the terranean surface 102, into a flow conduit 136 at an inlet 142, through the storage region 111, and back to the terranean surface 102 from the access drillhole portion 106, where the liquid 150 is analyzed. Of course, the direction of circulation of the liquid 150 can be reversed (e.g., flow from the terranean surface 102 into the access drillhole portion 106, through the storage region 111, and back to the surface 102 through the flow conduit 136). As shown in the example of FIG. 1A, the flow conduit 136 is fluidly coupled to the drillhole 104 at the storage region 111 at outlet 140. However, the flow conduit 136 can be fluidly coupled to the drillhole 104 at another location in the alternative (or at several locations).

The analysis of the liquid 150 from the access drillhole portion 106 can chemically indicate whether or not there is corrosion in the storage region 111 (e.g., an amount of corrosion). For example, the liquid 150 can be tested for dissolution of metal from the canisters 126 and/or casing 122 in the storage region 111. In some aspects, the analysis can determine from which metallic object(s) (e.g., the casing(s) or the canisters 126) the dissolved metal originated (e.g., based on a type of metal). Once analyzed, the liquid 150 can be purified (perhaps to adjust the pH, and to remove dissolved oxygen and other gases) and recirculated back through the flow conduit 136 and into the storage region 111 again.

The flow conduit 136 can take many example forms in the monitoring system. For example, the implementation shown in FIG. 1A shows a flow conduit in the form of a separate borehole 136 (or “flow hole”) that is formed downward from the terranean surface 102 in a substantially vertically (or slant, or directional) direction to intersect the storage region 111 of the directional drillhole 104, thereby creating fluid communication between the flow hole and the directional drillhole 104.

For this example implementation, after the repository 100 is constructed but before the waste canisters 126 are inserted, a separate borehole 136 can be drilled to intersect the repository 100 near or at the storage region 111. This borehole 136 can then be used to pump the liquid 150 (e.g., brine or fresh water) into the storage region 111. In some aspects, the borehole 136 is of a smaller diameter than the horizontal portion 110 (and other portions) of the directional drillhole 104. Although shown as a vertical borehole, the borehole 136 can also be directional, with its horizontal portion intersecting the storage region 111. Further, in some aspects, the hazardous waste repository 100 can be formed from a substantially vertical drillhole (without a horizontal portion) or a slant drillhole, while the borehole 136 can be a directional or slant drillhole to intersect the repository 100. In this example, however, the borehole 136 is free from hazardous waste canister 126.

FIG. 1B shows a schematic illustration of another example implementation of a hazardous waste repository 160 that includes a waste monitoring system according to the present disclosure. Hazardous waste repository 160 is similar to the example repository 100 but the flow conduit through which the liquid 150 is introduced into the storage region 111 is another directional drillhole 104. Thus, FIG. 1B shows two directional drillholes 104 (each with substantially vertical portions 106, radiussed portions 108, and substantially horizontal portions 110 with storage regions 111) that connect to each other. Thus, as shown, the liquid 150 can be circulated from the terranean surface 102 into one of the access drillhole portions 106, through both (or a combined, single) storage region(s) 111, and back to the surface 102 from the other access drillhole portion 106.

The repository configuration of FIG. 1B can be used, e.g., when existing directional drillholes 104 are spatially adjacent (and little drilling is needed to connect the two). As another example, the repository 160 can be used when a pilot hole is used to form the first of the two directional drillholes 104. In such an example, the flow conduit 136 can comprise a pilot hole. For example, when the first directional drillhole 104 is drilled, it may be done in more than one stage. A typical first stage is to drill a pilot hole, and then to use this to guide a larger “reamer” that widens the hole. When the pilot hole is dug, it goes from the surface to a kick-off point, curves to be horizontal (or near horizontal), and then ends at the end of the planned storage region 111. But instead of ending at that point, drilling can continue to form the second directional drillhole 104. Again, using directional drilling, the continued drilling turns upwards, and eventually reaches the surface. This extended pilot hole provides the other end of the required access to the storage region (e.g., another, different opening at the terranean surface), in addition to the access hole end.

As another example implementation that can be used with either repositories 100 or 160, the flow conduit 136 can comprise a drillhole of a size (e.g., diameter) that is similar to the directional drillhole 104. This is similar to the example implementation of the pilot hole, but in this example, a wider borehole 136 emerges at the end of the repository 100 at the surface. Such a hole might have other value, such as the ability to insert waste canisters 126 from both ends.

Turning back to FIG. 1A, as another example implementation, the flow conduit can comprise a catheter 155 (e.g., a hollow tube) that is inserted into the storage region 111 from the access drillhole portion 106. With such a catheter 155, the borehole 136 would not be needed for the repository 100. A downhole outlet 157 of the catheter 155 fluidly couples the catheter 155 to the storage region 111 so that liquid 150 can be circulated into the storage region 111 of the repository 100, which is then circulated (e.g., with a pumping system) back to the terranean surface 103 through the directional drillhole 104. Alternatively, the flow direction can be reversed in this example.

In some aspects, in order to fit such a catheter 155 into the directional drillhole 104, it may be useful to use a canister/casing system with a larger gap between canister 126 and casing 122 so there would be room for the catheter 155 to be run into the drillhole 104. In some aspects, the catheter 155 can be inserted after the canisters 126 are in place; alternatively, the catheter 155 can be put in place within the directional drillhole 104 prior to canister placement. In this latter implementation, the canisters can slide over the catheter 155 or otherwise push it aside.

In some aspects, the catheter 155 can be a hollow tube that is permanently attached to the casing(s) 120/122 (e.g., at the terranean surface 102), such as either an interior surface of the casing 122 (as shown) or an exterior surface of the casing 122 (adjacent the formation). At an end of the casing 122 within the storage region 111, the hollow tube 155 can be in fluid communication with the interior of the casing 122 (and thus, the storage region 111). In some aspects, an end of the hollow tube 155 can be initially sealed (e.g., during the casing installation and cementing processes) and then opened (e.g., ground, broken, or sheared open). In some aspects, the hollow tube 155 can be simply attached (e.g., strapped or otherwise) to an exterior surface of the casing(s) 120/122 during make-up of the casing joints on the rig at the terranean surface 102. The hollow tube 155 need not be circular in cross-section, but could be any cross-sectional shape as appropriate.

Each canister 126 can enclose hazardous material. Such hazardous material, in some examples, may be biological or chemical waste or other biological or chemical hazardous material. In some examples, the hazardous material may include nuclear material, such as spent nuclear fuel recovered from a nuclear reactor (e.g., commercial power or test reactor) or military nuclear material. For example, a gigawatt nuclear plant may produce 30 tons of spent nuclear fuel per year. The density of that fuel is typically close to 10 (10 gm/cm³=10 kg/liter), so that the volume for a year of nuclear waste is about 3 m³ . Spent nuclear fuel, in the form of nuclear fuel pellets, may be taken from the reactor and not modified. Nuclear fuel pellets are solid, and emit very little gas other than short-lived tritium (13 year half-life).

In some aspects, the storage layer 118 should be able to contain any radioactive output (e.g., gases) within the layer 118, even if such output escapes the canisters 126. For example, the storage layer 118 may be selected based on diffusion times of radioactive output through the layer 118. For example, a minimum diffusion time of radioactive output escaping the storage layer 118 may be set at, for example, fifty times a half-life for any particular component of the nuclear fuel pellets. Fifty half-lives as a minimum diffusion time would reduce an amount of radioactive output by a factor of 1×10⁻¹⁵. As another example, setting a minimum diffusion time to thirty half-lives would reduce an amount of radioactive output by a factor of one billion.

For example, plutonium-239 is often considered a dangerous waste product in spent nuclear fuel because of its long half-life of 24,100 years. For this isotope, 50 half-lives would be 1.2 million years. Plutonium- 239 has low solubility in water, is not volatile, and as a solid is not capable of diffusion through a matrix of the rock formation that comprises the illustrated storage layer 118 (e.g., shale, salt or other formation). The storage layer 118, for example comprised of shale, salt, or other formation, may offer the capability to have such isolation times (e.g., millions of years) as shown by the geological history of containing gaseous hydrocarbons (e.g., methane and otherwise) for several million years. In contrast, in conventional nuclear material storage methods, there was a danger that some plutonium might dissolve in a layer that comprised mobile ground water upon confinement escape.

In some aspects, the drillhole 104 may be formed for the primary purpose of long-term storage of hazardous materials. In alternative aspects, the drillhole 104 may have been previously formed for the primary purpose of hydrocarbon production (e.g., oil, gas). For example, storage layer 118 may be a hydrocarbon bearing formation from which hydrocarbons were produced into the drillhole 104 and to the terranean surface 102. In some aspects, the storage layer 118 may have been hydraulically fractured prior to hydrocarbon production. Further in some aspects, the production casing 122 may have been perforated prior to hydraulic fracturing. In such aspects, the production casing 122 may be patched (e.g., cemented) to repair any holes made from the perforating process prior to a deposit operation of hazardous material. In addition, any cracks or openings in the cement between the casing and the drill hole can also be filled at that time.

For example, in the case of spent nuclear fuel as a hazardous material, the drillhole may be formed at a particular location, e.g., near a nuclear power plant, as a new drillhole provided that the location also includes an appropriate storage layer 118, such as a shale formation. Alternatively, an existing well that has already produced shale gas, or one that was abandoned as “dry,” (e.g., with sufficiently low organics that the gas in place is too low for commercial development), may be selected as the drillhole 104. In some aspects, prior hydraulic fracturing of the storage layer 118 through the drillhole 104 may make little difference in the hazardous material storage capability of the drillhole 104. But such a prior activity may also confirm the ability of the storage layer 118 to store gases and other fluids for millions of years. If, therefore, the hazardous material or output of the hazardous material (e.g., radioactive gasses or otherwise) were to escape from the canister 126 and enter the fractured formation of the storage layer 118, such fractures may allow that material to spread relatively rapidly over a distance comparable in size to that of the fractures. In some aspects, the drillhole 104 may have been drilled for a production of hydrocarbons, but production of such hydrocarbons had failed, e.g., because the storage layer 118 comprised a rock formation (e.g., shale or otherwise) that was too ductile and difficult to fracture for production, but was advantageously ductile for the long-term storage of hazardous material.

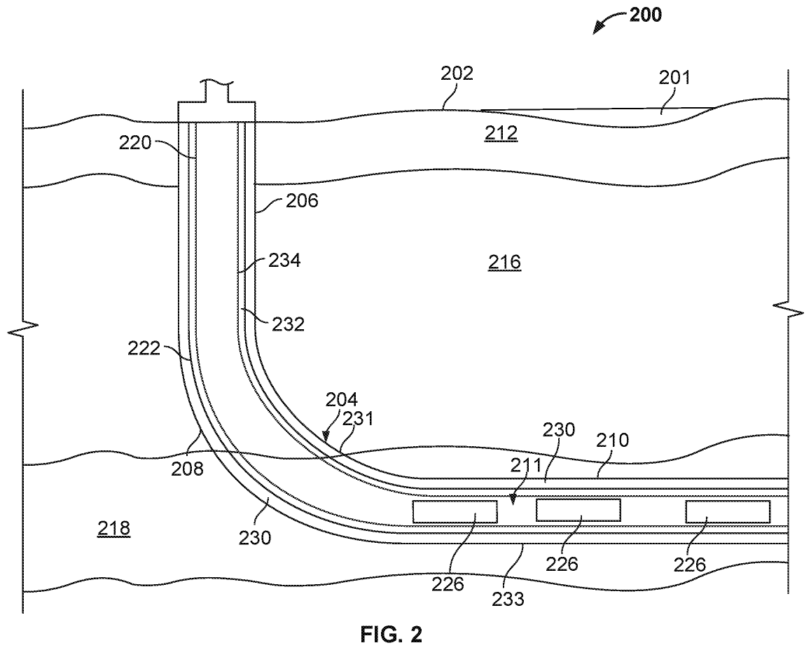

FIG. 2 is a schematic illustration of an example implementation of a hazardous waste repository 200 according to the present disclosure. This figure illustrates the example hazardous waste repository 200 subsequent to the emplacement of one or more hazardous waste canister 226 and during a monitoring operation with a waste monitoring system. As illustrated, the hazardous waste repository 200 includes a drillhole 204 formed (e.g., drilled or otherwise) from a terranean surface 202 and through multiple subterranean layers 212, 216, and 218. Although the terranean surface 202 is illustrated as a land surface, terranean surface 202 may be a sub-sea or other underwater surface, such as a lake or an ocean floor or other surface under a body of water. Thus, the present disclosure contemplates that the drillhole 204 may be formed under a body of water 201 from a drilling location on or proximate the body of water 201.

The illustrated drillhole 204 is a directional drillhole in this example of hazardous waste repository 200. For instance, the drillhole 204 includes a substantially vertical portion 206 coupled to a radiussed or curved portion 208, which in turn is coupled to a substantially horizontal portion 210. As used in the present disclosure, “substantially” in the context of a drillhole orientation, refers to drillholes that may not be exactly vertical (e.g., exactly perpendicular to the terranean surface 202) or exactly horizontal (e.g., exactly parallel to the terranean surface 202). In other words, those of ordinary skill in the drill arts would recognize that vertical drillholes often undulate offset from a true vertical direction, that they might be drilled at an angle that deviates from true vertical, and horizontal drillholes often undulate offset from a true horizontal direction. Further, the substantially horizontal portion 210, in some aspects, may be a slant drillhole or other directional drillhole that is oriented between exactly vertical and exactly horizontal. Further, the substantially horizontal portion 210, in some aspects, may be a slant drillhole or other directional well bore that is oriented to follow the slant of the formation. As illustrated in this example, the three portions of the drillhole 204—the vertical portion 206, the radiussed portion 208, and the horizontal portion 210—form a continuous drillhole 204 that extends into the Earth. A storage region 211 of, in this example, the horizontal portion 210 of the directional drillhole 204.

The illustrated drillhole 204 has a surface casing 220 positioned and set around the drillhole 204 from the terranean surface 202 into a particular depth in the Earth. For example, the surface casing 220 may be a relatively large-diameter tubular member (or string of members) set (e.g., cemented) around the drillhole 204 in a shallow formation. As used herein, “tubular” may refer to a member that has a circular cross-section, elliptical cross-section, or other shaped cross-section. For example, in this implementation of the hazardous waste repository 200, the surface casing 220 extends from the terranean surface through a surface layer 212. The surface layer 212, in this example, is a geologic layer comprised of one or more layered rock formations. In some aspects, the surface layer 212 in this example may or may not include freshwater aquifers, salt water or brine sources, or other sources of mobile water (e.g., water that moves through a geologic formation). In some aspects, the surface casing 212 may isolate the drillhole 204 from such mobile water, and may also provide a hanging location for other casing strings to be installed in the drillhole 204. Further, although not shown, a conductor casing may be set above the surface casing 212 (e.g., between the surface casing 212 and the surface 202 and within the surface layer 212) to prevent drilling fluids from escaping into the surface layer 212.

As illustrated, a production casing 222 is positioned and set within the drillhole 204 downhole of the surface casing 220. Although termed a “production” casing, in this example, the casing 222 may or may not have been subject to hydrocarbon production operations. Thus, the casing 222 refers to and includes any form of tubular member that is set (e.g., cemented) in the drillhole 204 downhole of the surface casing 220. In some examples of the hazardous waste repository 200, the production casing 222 may begin at an end of the radiussed portion 208 and extend throughout the substantially horizontal portion 210. The casing 222 could also extend into the radiussed portion 208 and into the vertical portion 206.

As shown, cement 230 is positioned (e.g., pumped) around the casings 220 and 222 in an annulus between the casings 220 and 222 and the drillhole 204. The cement 230, for example, may secure the casings 220 and 222 (and any other casings or liners of the drillhole 204) through the subterranean layers under the terranean surface 202. In some aspects, the cement 230 may be installed along the entire length of the casings (e.g., casings 220 and 222 and any other casings), or the cement 230 could be used along certain portions of the casings if adequate for a particular drillhole 204. The cement 230 can also provide an additional layer of confinement for the hazardous material in canisters 226.

The drillhole 204 and associated casings 220 and 222 may be formed with various example dimensions and at various example depths (e.g., true vertical depth, or TVD). For instance, a conductor casing (not shown) may extend down to about 120 feet TVD, with a diameter of between about 28 in. and 60 in. The surface casing 220 may extend down to about 2500 feet TVD, with a diameter of between about 22 in. and 48 in. An intermediate casing (not shown) between the surface casing 220 and production casing 222 may extend down to about 8000 feet TVD, with a diameter of between about 16 in. and 36 in. The production casing 222 may extend substantially horizontally (e.g., to case the substantially horizontal portion 210) with a diameter of between about 11 in. and 22 in. The foregoing dimensions are merely provided as examples and other dimensions (e.g., diameters, TVDs, lengths) are contemplated by the present disclosure. For example, diameters and TVDs may depend on the particular geological composition of one or more of the multiple subterranean layers (212, 216, 218), particular drilling techniques, as well as a size, shape, or design of a hazardous material canister 226 that contains hazardous material to be deposited in the hazardous waste repository 200. In some alternative examples, the production casing 222 (or other casing in the drillhole 204) could be circular in cross-section, elliptical in cross-section, or some other shape.

As illustrated, the drillhole 204 extends through subterranean layers 212 and 216 and lands in subterranean layer 218. As discussed above, the surface layer 212 may or may not include mobile water. Other subterranean layers between layers 212 and 218 can also include sources of mobile water, such as freshwater aquifers, salt water or brine, or other source of mobile water. In this example of hazardous waste repository 200, mobile water may be water that moves through a subterranean layer based on a pressure differential across all or a part of the subterranean layer. In this example, there can be an impermeable layer 216. The impermeable layer 216, in this example, may not allow mobile water to pass through. The impermeable layer 216 may have low permeability, e.g., on the order of nanodarcy permeability. Additionally, in this example, the impermeable layer 216 may be a relatively non-ductile (i.e., brittle) geologic formation. One measure of non-ductility is brittleness, which is the ratio of compressive stress to tensile strength. In some examples, the brittleness of the impermeable layer 216 may be between about 20 MPa and 40 MPa.

As shown in this example, the impermeable layer 216 is shallower (e.g., closer to the terranean surface 202) than the storage layer 218. In this example rock formations of which the impermeable layer 216 may be composed include, for example, certain kinds of sandstone, mudstone, clay, and slate that exhibit permeability and brittleness properties as described above. In alternative examples, the impermeable layer 216 may be deeper (e.g., further from the terranean surface 202) than the storage layer 218. In such alternative examples, the impermeable layer 216 may be composed of an igneous rock, such as granite.

The present disclosure contemplates that there may be many other layers between or among the illustrated subterranean layers 212, 216, and 218. For example, there may be repeating patterns (e.g., vertically), of one or more of the layers. Further, in some instances, the storage layer 218 may be directly adjacent (e.g., vertically) a mobile water layer, i.e., without an intervening impermeable layer 216.

Retrieval of the stored waste in the hazardous waste canisters 226 of the repository 200 can be impeded by distortion of the drillhole 204 by, e.g., stresses in the rock of the subterranean formation 218 and other tectonic activity. Such distortions may take many months-to-years-to-decades to become sufficient to interfere with retrieval (i.e., movement of the canister 226 that encloses the waste through the directional drillhole 204 to the terranean surface 202), but in some instances the regulations or public sentiment may require retrievability for a period of time that is longer than that of tectonic activity that causes distortions, such as 100 years. The example implementation of the hazardous waste repository 200 can facilitate 100-year retrievability of the hazardous (e.g., nuclear) waste from the human-unoccupiable, directional drillhole 204 formed in a subterranean formation with tectonic activity.

In this example, the directional drillhole 204 includes the access drillhole portion 206 that is vertical or substantially vertical and is formed in and through a first subterranean formation (subterranean formation 216) that is comprised of a rock formation with relatively high tectonic activity. An example of the first subterranean formation 216 is a sedimentary rock formation. The directional drillhole 204 includes the curved portion 208 coupled to the access drillhole portion 206. At least part of the curved portion 208 (e.g., starting at a kick-off point) can also be formed in the first subterranean formation 216 as shown. The directional drillhole 204 also includes the horizontal (or substantially horizontal) drillhole portion 210 coupled to the curved portion 208. A first part 231 of the horizontal drillhole portion 210 (e.g., directly coupled to the curved portion 208) can also be formed in the first subterranean formation 216 as shown. A second part 233 of the horizontal drillhole portion 210 (e.g., directly coupled to the first part 231) can be formed in a second subterranean formation (e.g., the storage layer 218) that that is comprised of a rock formation with tectonic activity lower than the first subterranean formation 216. In some aspects, the second subterranean formation 218 is deeper than and underneath (e.g., directly) the first subterranean formation 216. An example of a second subterranean formation 218 is a sedimentary rock formation.

As shown in FIG. 2, the first subterranean formation 216 (through which the access drillhole portion 206 is formed and the curved portion 208 starts) is a sedimentary rock formation in this example. In certain geologies of interest, the rock that is most susceptible to distortion is a sedimentary layer. Off the coast of Japan, for example, certain areas have a sedimentary overlayer about 1000 meters thick, with crystalline basement rock below. Thus, as shown in this example, the second subterranean formation 218 (into which the curved portion 208 lands and the horizontal drillhole portion extends 210) is a crystalline basement rock. In this example, the hazardous waste repository 200 uses both formations (sedimentary rock and crystalline basement rock) in combination to achieve relatively low cost yet high likelihood that the hazardous waste canisters 226 can be retrieved even should tectonic movement in the sedimentary rock cause all or partial collapse of the access drillhole 206 or curved portion 208. In some aspects, the path of the drillhole 204 is chosen such that most of the access drillhole portion 206 is in sedimentary rock (formation 216), but all or most of the horizontal drillhole portion 210—and especially the storage region 211 that contains the hazardous waste canisters 226—is formed in the crystalline basement rock, as shown in FIG. 2.

In the example of FIG. 2, because the access drillhole portion 206 is in sedimentary rock, creep and other movement of the rock (tectonic or otherwise) can cause the access drillhole 206 to distort and even to close. In this example, closure or distortion of the access drillhole portion 206 (or even curved portion 208) does not prevent retrieval, since this part of the repository 200 contains no waste, can be left open (e.g., or filled only with brine, or some other easily removed material such as gravel or cement) and can be drilled out if it changes shape. However, the part of the directional drillhole 204 that cannot be drilled out (or at least safely or easily drilled out) because it contains hazardous material is the storage region 211 of the horizontal drillhole portion 204. But this region 211 can be formed entirely within the crystalline basement rock, which has sufficient stability that it will allow recovery for periods of a century or longer due to lack of distortion or closure during tectonic activity.

In some aspects, all of the horizontal drillhole portion 210 can be formed in the second subterranean formation 218 (i.e., the crystalline basement rock), which, e.g., can be 1000 meters deep. In some aspects, some of the horizontal drillhole portion 210, e.g., the portion 231 closest to the curved portion 208, can be formed in the first subterranean formation 216 (i.e., the sedimentary rock) but kept free from any hazardous waste canisters 226, while the rest of the horizontal drillhole portion 210 can be formed in the second subterranean formation 218 and includes the storage region 211 in which the hazardous waste canisters 226 are emplaced.

In some aspects, the initial section 231 of the horizontal drillhole portion 210 (e.g., closest to the surface 202) is left open, that is, with no waste canisters 226, to also allow monitors to verify that no significant distortion is taking place in the crystalline basement rock with tectonic or seismic activity. In addition, that empty region 231 can serve as length of empty drillhole in which an accidentally released and falling canister 226 (e.g., free-falling through the access drillhole portion 206) can safely come to a stop without hitting previously emplaced canisters 226 in the storage region 211. Similar retrievability capability can be achieved using a storage region 211 that is vertical or slanted (rather than substantially horizontal) as long as the storage section is formed largely or entirely in the second subterranean formation 218 that has a reduced or no tectonic movement (such as the crystalline basement rock). The disadvantages of such a configuration are that (1) the canisters must be suspended in a manner that prevents the weight of the upper canisters from crushing the lower canisters; the suspension mechanism can interfere with retrieval, and (2) drilling deep boreholes in hard crystalline basement rock is often more expensive than drilling a similar length horizontally, because of the added rock pressure at greater depths.

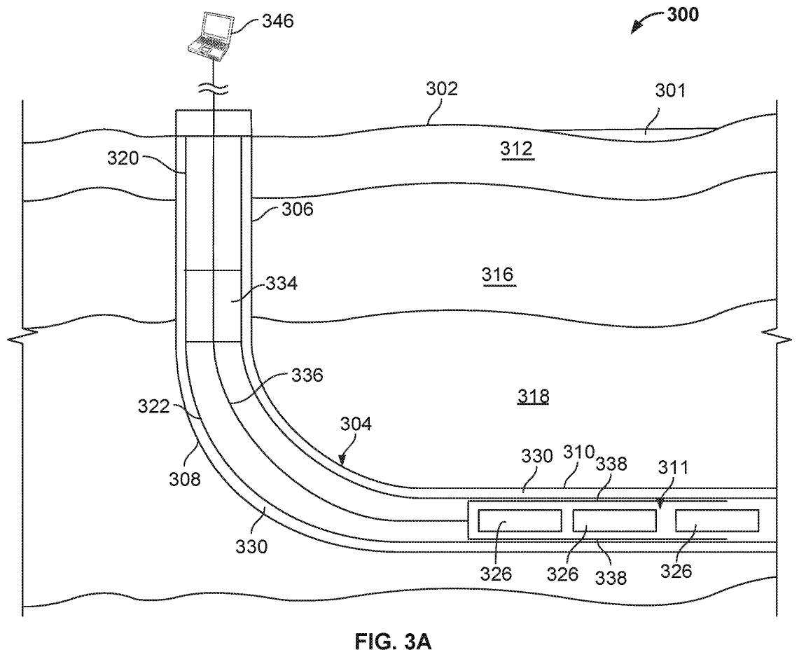

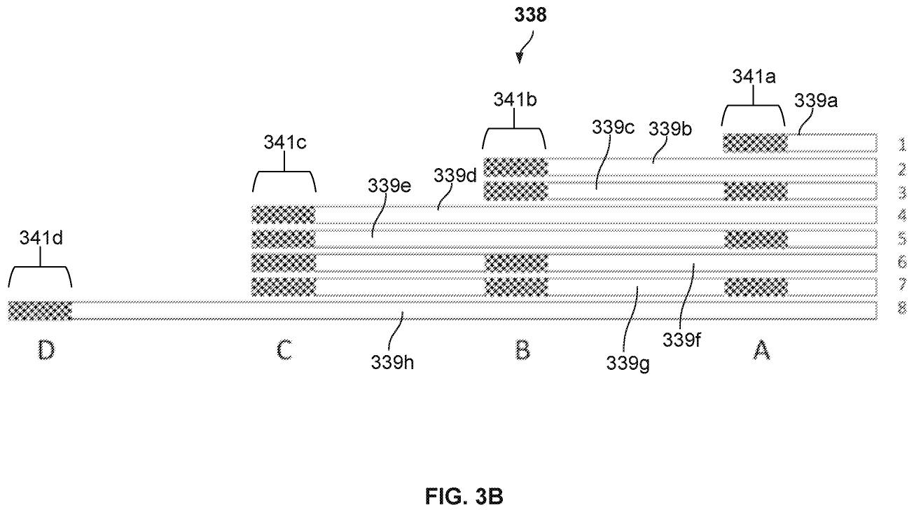

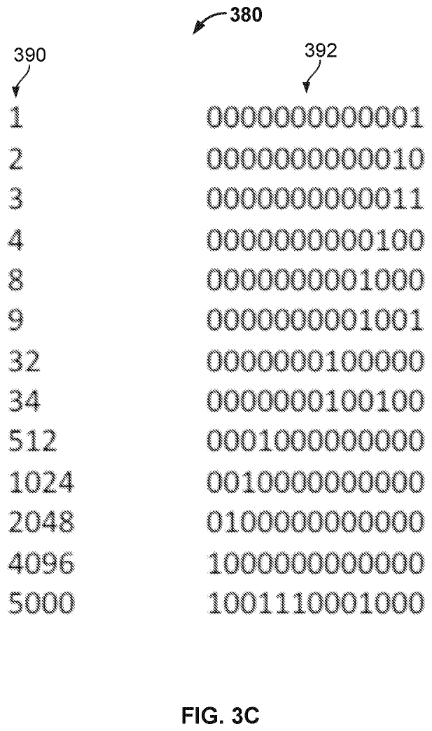

FIG. 3A is a schematic illustration of another example implementation of a hazardous waste repository 300 that includes a waste monitoring system that includes fiber optic scintillators according to the present disclosure. For example, downhole monitoring of radioactive waste can be done with gamma ray sensors, which typically consist of scintillators attached to fiber optics. Such sensors are currently used in the drilling industry to obtain gamma ray “logs” (e.g., records) of the gamma rays from natural radioisotopes (e.g., from uranium, thorium, or potassium) as well as from induced rock radioactivity (e.g., from neutron generators).

With a long, linear array of nuclear fuel stored in hazardous waste canisters in a human-unoccupiable drillhole (vertical, slant, or directional), there is interest in monitoring to determine changes in the radioactivity that might indicate, for example, failure of a local engineered barrier (e.g., a spent nuclear fuel canister that stores the nuclear waste in the drillhole). Such monitoring can be done by having a large number of detectors. For example, in a 2 mile long horizontal disposal section of a directional drillhole that is, e.g., two miles in length, there might be 5,000 canisters. Conventionally, a radiation monitor might be placed between each pair of adjacent canisters. This would require about 5,000 monitors, and that results in 5,000 cables (e.g., fiber optic) that transmit signals to the surface. Such a large number of cables creates a large bundle that requires a large pathway to the surface. That pathway creates a potential leakage pathway that reduces the safety of the disposal of the nuclear waste

For spent nuclear fuel, if there is no local release from the canisters, then both the total radioactivity and the local radioactivity may decrease with time. For spent nuclear fuel, the decrease for the first hundred years comes from the decay of the isotopes strontium-90 and cesium-137. If there is a breach in one of the canisters, then these isotopes might leak from the canisters and, by moving closer to the gamma detectors, create a localized increase in the gamma ray detection rate for that detector. Because the radiation levels for nuclear waste are much higher than in the natural environment, typically by a factor of more than a million, the size of the scintillator required to detect a breach in one of the canisters is correspondingly reduced. In fact, the entire fiber may behave as a scintillator, and so this will present a background rate that must be reduced.

FIG. 3A shows an example implementation of a drillhole radiation monitoring systems and methods that utilize a relatively small number of fiber optic cables to be used to allow the determination of the location of a change in gamma radiation over a large distance. Such an economy of fibers can be important both for ease of implementation and because it minimizes the creation of a possible leakage path for the radioactive material that creates the gamma radiation.

As illustrated, the hazardous waste repository 300 includes a drillhole 304 formed (e.g., drilled or otherwise) from a terranean surface 302 and through multiple subterranean layers 312, 316, and 318. Although the terranean surface 302 is illustrated as a land surface, terranean surface 302 may be a sub-sea or other underwater surface, such as a lake or an ocean floor or other surface under a body of water. Thus, the present disclosure contemplates that the drillhole 304 may be formed under a body of water 301 from a drilling location on or proximate the body of water 301.

The illustrated drillhole 304 is a directional drillhole in this example of hazardous waste repository 300. For instance, the drillhole 304 includes a substantially vertical portion 306 coupled to a radiussed or curved portion 308, which in turn is coupled to a substantially horizontal portion 310. As used in the present disclosure, “substantially” in the context of a drillhole orientation, refers to drillholes that may not be exactly vertical (e.g., exactly perpendicular to the terranean surface 302) or exactly horizontal (e.g., exactly parallel to the terranean surface 302). In other words, those of ordinary skill in the drill arts would recognize that vertical drillholes often undulate offset from a true vertical direction, that they might be drilled at an angle that deviates from true vertical, and horizontal drillholes often undulate offset from a true horizontal direction. Further, the substantially horizontal portion 310, in some aspects, may be a slant drillhole or other directional drillhole that is oriented between exactly vertical and exactly horizontal. Further, the substantially horizontal portion 310, in some aspects, may be a slant drillhole or other directional well bore that is oriented to follow the slant of the formation. As illustrated in this example, the three portions of the drillhole 304-the vertical portion 306, the radiussed portion 308, and the horizontal portion 310-form a continuous drillhole 304 that extends into the Earth. A storage region 311 of, in this example, the horizontal portion 310 of the directional drillhole 304.

The illustrated drillhole 304 has a surface casing 320 positioned and set around the drillhole 304 from the terranean surface 302 into a particular depth in the Earth. For example, the surface casing 320 may be a relatively large-diameter tubular member (or string of members) set (e.g., cemented) around the drillhole 304 in a shallow formation. As used herein, “tubular” may refer to a member that has a circular cross-section, elliptical cross-section, or other shaped cross-section. For example, in this implementation of the hazardous waste repository 300, the surface casing 320 extends from the terranean surface through a surface layer 312. The surface layer 312, in this example, is a geologic layer comprised of one or more layered rock formations. In some aspects, the surface layer 312 in this example may or may not include freshwater aquifers, salt water or brine sources, or other sources of mobile water (e.g., water that moves through a geologic formation). In some aspects, the surface casing 312 may isolate the drillhole 304 from such mobile water, and may also provide a hanging location for other casing strings to be installed in the drillhole 304. Further, although not shown, a conductor casing may be set above the surface casing 312 (e.g., between the surface casing 312 and the surface 302 and within the surface layer 312) to prevent drilling fluids from escaping into the surface layer 312.

As illustrated, a production casing 322 is positioned and set within the drillhole 304 downhole of the surface casing 320. Although termed a “production” casing, in this example, the casing 322 may or may not have been subject to hydrocarbon production operations. Thus, the casing 322 refers to and includes any form of tubular member that is set (e.g., cemented) in the drillhole 304 downhole of the surface casing 320. In some examples of the hazardous waste repository 300, the production casing 322 may begin at an end of the radiussed portion 308 and extend throughout the substantially horizontal portion 310. The casing 322 could also extend into the radiussed portion 308 and into the vertical portion 306.

As shown, cement 330 is positioned (e.g., pumped) around the casings 320 and 322 in an annulus between the casings 320 and 322 and the drillhole 304. The cement 330, for example, may secure the casings 320 and 322 (and any other casings or liners of the drillhole 304) through the subterranean layers under the terranean surface 302. In some aspects, the cement 330 may be installed along the entire length of the casings (e.g., casings 320 and 322 and any other casings), or the cement 330 could be used along certain portions of the casings if adequate for a particular drillhole 304. The cement 330 can also provide an additional layer of confinement for the hazardous material in canisters 326.

The drillhole 304 and associated casings 320 and 322 may be formed with various example dimensions and at various example depths (e.g., true vertical depth, or TVD). For instance, a conductor casing (not shown) may extend down to about 120 feet TVD, with a diameter of between about 28 in. and 60 in. The surface casing 320 may extend down to about 2500 feet TVD, with a diameter of between about 22 in. and 48 in. An intermediate casing (not shown) between the surface casing 320 and production casing 322 may extend down to about 8000 feet TVD, with a diameter of between about 16 in. and 36 in. The production casing 322 may extend substantially horizontally (e.g., to case the substantially horizontal portion 310) with a diameter of between about 11 in. and 22 in. The foregoing dimensions are merely provided as examples and other dimensions (e.g., diameters, TVDs, lengths) are contemplated by the present disclosure. For example, diameters and TVDs may depend on the particular geological composition of one or more of the multiple subterranean layers (312, 316, 318), particular drilling techniques, as well as a size, shape, or design of a hazardous material canister 326 that contains hazardous material to be deposited in the hazardous waste repository 300. In some alternative examples, the production casing 322 (or other casing in the drillhole 304) could be circular in cross-section, elliptical in cross-section, or some other shape.

As illustrated, the drillhole 304 extends through subterranean layers 312 and 316 and lands in subterranean layer 318. As discussed above, the surface layer 312 may or may not include mobile water. Other subterranean layers between layers 312 and 318 can also include sources of mobile water, such as freshwater aquifers, salt water or brine, or other source of mobile water. In this example of hazardous waste repository 300, mobile water may be water that moves through a subterranean layer based on a pressure differential across all or a part of the subterranean layer. In this example, there can be an impermeable layer 316. The impermeable layer 316, in this example, may not allow mobile water to pass through. The impermeable layer 316 may have low permeability, e.g., on the order of nanodarcy permeability. Additionally, in this example, the impermeable layer 316 may be a relatively non-ductile (i.e., brittle) geologic formation. One measure of non-ductility is brittleness, which is the ratio of compressive stress to tensile strength. In some examples, the brittleness of the impermeable layer 316 may be between about 20 MPa and 40 MPa.

As shown in this example, the impermeable layer 316 is shallower (e.g., closer to the terranean surface 302) than the storage layer 318. In this example rock formations of which the impermeable layer 316 may be composed include, for example, certain kinds of sandstone, mudstone, clay, and slate that exhibit permeability and brittleness properties as described above. In alternative examples, the impermeable layer 316 may be deeper (e.g., further from the terranean surface 302) than the storage layer 318. In such alternative examples, the impermeable layer 316 may be composed of an igneous rock, such as granite.

The present disclosure contemplates that there may be many other layers between or among the illustrated subterranean layers 312, 316, and 318. For example, there may be repeating patterns (e.g., vertically), of one or more of the layers. Further, in some instances, the storage layer 318 may be directly adjacent (e.g., vertically) a mobile water layer, i.e., without an intervening impermeable layer 316.

As shown, one or more fiber optic cables 338 are run into and placed in the drillhole 304 (e.g., within the substantially horizontal portion 310) and communicably coupled to a monitoring control system 346 through a cable 336 (e.g., electrical, optical, hydraulic, or otherwise). Although illustrated as within drillhole 304 (e.g., inside of the casings), the fiber optic cables 338 may be placed outside of the casings, or even built into the casings before the casings are installed in the drillhole 304. Fiber optic cables 338 (of which there can be one, some, or many) can each include multiple (e.g., 1, 2, 3, 4, 5, 6, 7, 8, or more) fibers (as discussed with reference to FIG. 3B).

In some implementations, gamma and other radioactivity may be measured along a large distance through the use of the plurality of fiber optic cables 338 with scintillators located along each cable's length. In some aspects, a scintillator can be created by doping a plastic with a fluorescent material. In an example implementation, the scintillator may be created by impregnating a fiber itself with a fluorescent material. In an example implementation, the fiber is impregnated at discrete locations, for example, in between the hazardous waste canisters 326 and at the ends of the line of canisters that are stored in the horizontal drillhole portion 310 of the directional drillhole 304. In such implementations, the section of each fiber (of the fiber optic cables 338) impregnated with a fluorescent material acts as the scintillator for that location. Leaked radiation from the hazardous waste canisters 326 can cause a particular scintillator to be active, i.e., increase in fluorescent light intensity, thereby providing a light source through the optical fiber (and thus the cable 338) to which the lighted scintillator is attached or embedded. The fluorescent light intensity can then be transmitted through the optical fiber cable 338, e.g., to the control system 346 at the terranean surface 302, in order for the control system 346 to determine which optical fiber (and which scintillator) has the lighted indication.

As another example, each fiber strand in the fiber optic cable 338 can be impregnated with the fluorescent material only at one or both ends of the fiber. In such example implementation, one fiber may be used for each region of interest in the drillhole 304. If, for example, there were 5,000 gaps between disposal canisters 326 (e.g., that store the nuclear waste), the impregnated end of each of the 5,000 fibers can be run into the drillhole 304 and positioned at each gap (e.g., between canisters 326 or at an end of each canister 326).

In an example implementation, the scintillators can be arranged (e.g., attached) in a coded pattern. In some aspects, the code is binary. For example, if there are 5,000 canisters 326 within the horizontal portion 310 of the directional drillhole 304, then an end of the first canister 326 (e.g., a canister 326 located at a distal end of the storage region 311 opposite the curved drillhole portion 308) would have code equal to 1, expressed in a thirteen-digit binary code as 000000001. The second canister 326 (located closer to the curved drillhole portion 308 than the first canister 326) would have an end with code equal to 2, expressed in binary as 000000010. The third canister 326 would have binary expression 0000000011 (i.e., code equal to 3), and so on. FIG. 3C shows a table 380 that gives examples of numbers written in both decimal and binary. Column 390 shows the decimal and column 392 shows the binary. Note that the first number, 0000000000001 =1. The second number, 2=0000000000010 =2, and the third entry, 3 =0000000000011=1+2=3, thus showing the correlation between the code number and the binary representation of that number.

In the example implementation with 5,000 scintillators attached to, or formed on, thirteen fiber optic cables, each scintillator is attached to one of the fibers and corresponds with a binary representation of the location of the scintillator. For example, because the binary representation of the first location is 0000000000001, the first scintillator can be connected only to the first fiber. Scintillator number 3 will be connected to both of the first two fibers (because its binary representation is 0000000000011=3). Scintillator number 7 can be connected to each of the first three fibers (because its binary representation is 0000000000111=7). Similarly, in this example, scintillator number 5,000 can be connected to fibers 4, 8, 9, 10, 13. In that case, a leak near scintillator number 5,000 will result in an increase in the light from fibers 4, 8, 9, 10, and 13, identifying the location of the scintillator.

In another example implementation, each fiber can be sensitized with fluorescent material at 1 to 5,000 different locations along its length to create between 1 and 5,000 scintillators along the fiber. In this implementation, each fiber can get its primary sensitivity at those discrete locations. For example, only fibers number 4, 8, 9, and 13 would have fluorescent material impregnated at the location number 5,000. If all four of these fibers indicated an increase in radioactivity, and none others did, then the location of the increased radioactivity could be known (in this example, at location 5,000). This representation in binary is unique so the combination of fibers indicating an increase in radioactivity is unique.

FIG. 3B shows a representation of this example. FIG. 3B shows an example where there are eight fibers 339a-h in a single fiber optic cable 338. The eight fibers 339a-h (labeled 1, 2, 3, 4, 5, 6, 7, 8) combine to form four regions 341a-d or locations at which the fibers 339a-h are sensitized to gamma radiation (marked with a checkerboard pattern). In this example, the eight fibers 339a-h are positioned in the directional drillhole 304 as part of the fiber optic cable 338. These 4 regions are labeled A, B, C, and D in FIG. 3B. If there is a pulse of gamma rays at region A, it will result in a signal to fibers 339a, 339c, 339e, and 339339g) (fibers 1, 3, 5, and 7). If there is a pulse at D, it will be sent to fiber 339h (fiber 8). The coding, based on binary arithmetic, is unique. For example, if a signal is received by fibers 339d, 339e, 339f, and 339339g (fibers 4, 5, 6, and 7), but not at fibers 339a, 339b, 339c, or 339h (fibers 1, 2, 3, or 8), then it is known that the gamma radiation occurred at region 341c (location C).

In FIG. 3B, the width of the fibers 339a-h is exaggerated compared to the spacing between regions 341a-d for demonstration. In the directional drillhole 304 that stores nuclear waste in the hazardous waste canisters 326, an example width of each fiber might be 1 mm, and an example distance between sensitized regions 341 a-d might be 5 meters, 5,000 times greater than the width. Additionally, although eight fibers are used in the example representation of FIG. 3B, alternative implementations can use other number of fibers, such as 13 fibers (e.g., per fiber optic cable 338) to cover 5000 regions.

In other implementations, any permutation of the table 380 shown in FIG. 3C can still maintain a 1-1 correspondence between the scintillator and the binary code. For any of these, thirteen fibers would be sufficient to identify 5,000 regions. In some aspects, there may be an advantage to using such permutations. As an example, a “Gray Code” is a permutation in which adjacent scintillators differ in their coding by no more than one binary digit. In some aspects, use of a Gray Code could be beneficial to location if one fiber fails.

In another aspect of the disclosure, there may additional fibers used to create an “error-correcting code.” An error correcting code typically consists of log N additional fibers, where N is the number of fibers to be corrected. In the example implementation in which N=13, the addition of four fibers would allow the determination, when a signal is sent, which fiber failed. This would allow a correction, and the correct identification of the scintillator, even in the presence of a failed fiber. Additional fibers could be added to allow additional error correction, for example, if two fibers were to fail.

In some aspects, there is no need to extend fiber 339a (fiber 1) beyond region 341a (location A), and no need to extend fibers 339b and 339c (fibers 2 and 3) beyond region 341b (location B). Such economy of fiber both reduces the amount of fiber needed, and reduces the background levels of signal from gamma radiation hitting the insensitive (e.g., non-impregnated) regions of the fibers.

In an example implementation, the fibers 339a-h can be placed outside of the casing 322 (e.g., a steel casing) that is installed in the directional drillhole 304, such as between the casing 322 and the subterranean formation 318 into which the directional drillhole 304 is formed. For instance, due to the penetrating nature of gamma rays, fibers installed outside the casing 322 may detect such radiation as sufficiently as fibers installed within the casing 322. In implementations specific to the measurement of alpha and beta radiation, the fibers 339a-h (and thus, the scintillators) may be placed inside the casing, since a centimeter of carbon steel or other metal may stop both alpha and beta rays.

In some aspects, in reducing the number of fibers needed from 5,000 to thirteen (or more than thirteen, such as nineteen, with error-correcting coding), the volume of the fiber bundle can be reduced by a similar factor (e.g., 1/385 for 13 fibers). This reduction offers a significant reduction in the potential future leakage path to the surface 302 when the fiber pathway could offer a route to the surface for released radioactive materials. In some aspects, that release can be minimized by using fibers made from a material, such as glass, that is less likely to degrade over time than would, e.g., a plastic fiber.

In alternative implementations, a scintillator on a fiber can be external from the fiber optic cable 338 (e.g., attached to the cable) rather than being a region of the fiber that has been sensitized. The external scintillators can be connected to the fiber along its length at the appropriate locations in such a way that a substantial part of the light from the scintillator is transmitted along the fiber to a light detector at the end of the fiber.

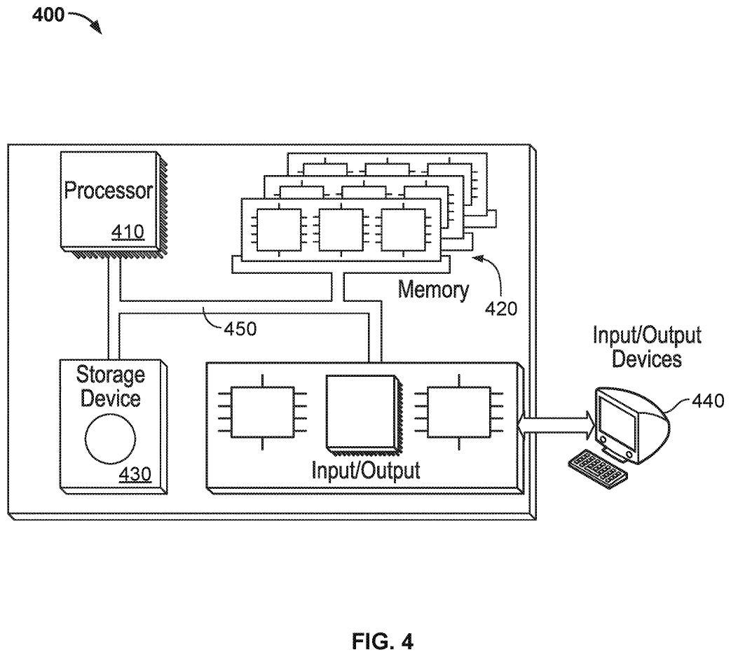

FIG. 4 is a schematic illustration of an example controller 400 (or control system) for an on-board fuel separation system. For example, the controller 400 can be used for the operations described previously, for example as or as part of the monitoring control system 346. For example, the controller 400 may be communicably coupled with, or as a part of, a hazardous waste repository as described herein.

The controller 400 is intended to include various forms of digital computers, such as printed circuit boards (PCB), processors, digital circuitry, or otherwise that is part of a vehicle. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 400 includes a processor 410, a memory 420, a storage device 430, and an input/output device 440. Each of the components 410, 420, 430, and 440 are interconnected using a system bus 450. The processor 410 is capable of processing instructions for execution within the controller 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the controller 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the controller 400. In one implementation, the storage device 430 is a computer-readable medium. In various different implementations, the storage device 430 may be a floppy disk device, a hard disk device, an optical disk device, a tape device, flash memory, a solid state device (SSD), or a combination thereof.

The input/output device 440 provides input/output operations for the controller 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The present disclosure describes example implementations of systems and methods for storing and/or monitoring hazardous waste in a hazardous waste repository. For example, in a first example implementation, a method for detecting radiation includes placing a plurality of optical fibers in a human-unoccupiable directional drillhole that includes a hazardous waste repository that stores a plurality of nuclear waste canisters that enclose nuclear waste, each of the plurality of optical fibers including at least one radiation-sensitive scintillator; positioning the plurality of optical fibers within the drillhole adjacent the plurality of nuclear waste canisters; detecting one or more optical fibers lighted by one or more of the plurality of radiation-sensitive scintillators; and determining a presence of leaked radiation originating from at least one of the stored nuclear waste canisters based, at least in part, on the detected one or more lighted optical fibers.

In an aspect combinable with the first example implementation, the determining further includes determining the presence of leaked radiation originating from at least one of the stored nuclear waste canisters based, at least in part, on one or more unlighted optical fibers.

Another aspect combinable with any of the previous aspects of the first example implementation identifying a location of the leaked radiation within the hazardous waste repository based on the detected one or more lighted optical fibers.

Another aspect combinable with any of the previous aspects of the first example implementation forming at least one radiation-sensitive scintillator to each optical fiber of the plurality of optical fibers.

In another aspect combinable with any of the previous aspects of the first example implementation, the forming includes at least one of connecting a fluorescently-doped material to each optical fiber at a plurality of locations along a length of each optical fiber; or impregnating each optical fiber with a fluorescent material at a plurality of locations along a length of each optical fiber.

In another aspect combinable with any of the previous aspects of the first example implementation, each of the plurality of locations includes a discrete distance from an end of at least one of the plurality of nuclear waste canisters.

In another aspect combinable with any of the previous aspects of the first example implementation, one of the plurality of locations includes a terminal end of a respective optical fiber.

Another aspect combinable with any of the previous aspects of the first example implementation assigning a unique number to each optical fiber of the plurality of optical fibers.

In another aspect combinable with any of the previous aspects of the first example implementation, each optical fiber represents a bit in a binary encoding and each unique number represents a respective bit location in the binary encoding.

Another aspect combinable with any of the previous aspects of the first example implementation determining the absence of the leaked radiation based on an unlighted one or more optical fiber.

In another aspect combinable with any of the previous aspects of the first example implementation, the lighted particular optical fiber represents a binary “1” in the binary encoding, each unlighted optical fiber represents a binary “0” in the binary encoding.

Another aspect combinable with any of the previous aspects of the first example implementation assigning each end of each of the plurality of nuclear waste canisters a unique number that represents a location of the particular end within the hazardous waste repository.

In another aspect combinable with any of the previous aspects of the first example implementation, positioning the plurality of optical fibers within the drillhole adjacent the plurality of nuclear waste canisters includes positioning the plurality of optical fibers within the drillhole adjacent the plurality of nuclear waste canisters such that each end of each of the plurality of nuclear waste canisters has at least one radiation-sensitive scintillators adjacent thereto in the hazardous waste repository.

Another aspect combinable with any of the previous aspects of the first example implementation identifying the location of the leaked radiation based on a binary representation of a combination of scintillators proximate to it from at least one of the optical fibers of the plurality of optical fibers that, when lighted, and in combination with the unlighted optical fibers, creates a binary representation of that end's location number.

In another aspect combinable with any of the previous aspects of the first example implementation, a portion of the plurality of optical fibers are configured to act as an error-correcting code performing functions including identifying a faulty optical fiber; and correcting a faulty signal sent by the faulty optical fiber.

In another aspect combinable with any of the previous aspects of the first example implementation, there are log₂N optical fibers in the portion of optical fibers, where N is a number of the plurality of optical fibers.

In a second example implementation, a radiation detection system includes a plurality of optical fibers positioned in a human-unoccupiable directional drillhole that includes a hazardous waste repository that stores a plurality of nuclear waste canisters that enclose nuclear waste. Each of the plurality of optical fibers includes at least one radiation-sensitive scintillator adjacent at least one of the plurality of nuclear waste canisters. The system includes a control system positioned at or near a terranean surface and coupled to the plurality of optical fibers. The control system is configured to perform operations including detecting one or more optical fibers lighted by one or more of the plurality of radiation-sensitive scintillators; and determining a presence of leaked radiation originating from at least one of the stored nuclear waste canisters based, at least in part, on the detected one or more lighted optical fibers.

In an aspect combinable with the second example implementation, the operation of determining further includes determining the presence of leaked radiation originating from at least one of the stored nuclear waste canisters based, at least in part, on one or more unlighted optical fibers.

In another aspect combinable with any of the previous aspects of the second example implementation, the control system is configured to perform further operations including identifying a location of the leaked radiation within the hazardous waste repository based on the detected one or more lighted optical fibers.

In another aspect combinable with any of the previous aspects of the second example implementation, at least one radiation-sensitive scintillator is formed to each optical fiber of the plurality of optical fibers.

In another aspect combinable with any of the previous aspects of the second example implementation, the at least one radiation-sensitive scintillator includes at least one of: a fluorescently-doped material attached to each optical fiber at a plurality of locations along a length of each optical fiber; or a fluorescent material impregnated into each optical fiber at a plurality of locations along a length of each optical fiber.

In another aspect combinable with any of the previous aspects of the second example implementation, each of the plurality of locations includes a discrete distance from an end of at least one of the plurality of nuclear waste canisters.

In another aspect combinable with any of the previous aspects of the second example implementation, one of the plurality of locations includes a terminal end of a respective optical fiber.

In another aspect combinable with any of the previous aspects of the second example implementation, each optical fiber of the plurality of optical fibers is assigned a unique number.

In another aspect combinable with any of the previous aspects of the second example implementation, each optical fiber represents a bit in a binary encoding and each unique number represents a respective bit location in the binary encoding.

In another aspect combinable with any of the previous aspects of the second example implementation, the control system is configured to perform further operations including determining the absence of the leaked radiation based on an unlighted one or more optical fiber.

In another aspect combinable with any of the previous aspects of the second example implementation, the lighted particular optical fiber represents a binary “1” in the binary encoding, each unlighted optical fiber represents a binary “0” in the binary encoding.

In another aspect combinable with any of the previous aspects of the second example implementation, each end of each of the plurality of nuclear waste canisters is assigned a unique number that represents a location of the particular end within the hazardous waste repository.

In another aspect combinable with any of the previous aspects of the second example implementation, the plurality of optical fibers are positioned within the drillhole adjacent the plurality of nuclear waste canisters such that each end of each of the plurality of nuclear waste canisters has at least one radiation-sensitive scintillators adjacent thereto in the hazardous waste repository.

In another aspect combinable with any of the previous aspects of the second example implementation, the control system is configured to perform further operations including identifying the location of the leaked radiation based on a binary representation of a combination of scintillators proximate to it from at least one of the optical fibers of the plurality of optical fibers that, when lighted, and in combination with the unlighted optical fibers, creates a binary representation of that end's location number.

In another aspect combinable with any of the previous aspects of the second example implementation, a portion of the plurality of optical fibers are configured to act as an error-correcting code performing functions including identifying a faulty optical fiber; and correcting a faulty signal sent by the faulty optical fiber.

In another aspect combinable with any of the previous aspects of the second example implementation, there are log₂N optical fibers in the portion of optical fibers, where N is a number of the plurality of optical fibers.

In a third example implementation, a hazardous waste repository includes a substantially vertical access drillhole portion formed from a terranean surface into a first subterranean formation having relatively high tectonic activity; a curved portion coupled to the substantially vertical access drillhole portion, at least a part of the curved portion formed in the first subterranean formation; and a substantially horizontal drillhole portion coupled to the curved portion and formed in a second subterranean formation having relatively low tectonic activity compared to the first subterranean formation. The substantially horizontal drillhole portion includes a storage region configured to store one or more hazardous waste canisters that enclose hazardous waste. The substantially vertical access drillhole portion and the curved portion are free of the one or more hazardous waste canisters.

In an aspect combinable with the third example implementation, the third subterranean formation includes a sedimentary rock formation.

In another aspect combinable with any of the previous aspects of the third example implementation, the second subterranean formation includes a crystalline basement rock formation.

In another aspect combinable with any of the previous aspects of the third example implementation, each of the substantially vertical access drillhole portion and the curved portion includes a re-drillable drillhole portion in response to a distortion or collapse caused by tectonic or seismic activity.

In another aspect combinable with any of the previous aspects of the third example implementation, the substantially horizontal drillhole portion includes a first part coupled to the curved portion and a second part coupled to the first part that includes the storage region.

In another aspect combinable with any of the previous aspects of the third example implementation, the first part of the substantially horizontal drillhole portion is formed at least partially in the first subterranean formation.

In another aspect combinable with any of the previous aspects of the third example implementation, the first part of the substantially horizontal drillhole portion is free of the one or more hazardous waste canisters.

In another aspect combinable with any of the previous aspects of the third example implementation, the first part of the substantially horizontal drillhole portion includes a length configured for a free-falling hazardous waste canister to come to a stop without hitting the one or more hazardous waste canisters in the storage region.

In another aspect combinable with any of the previous aspects of the third example implementation, the hazardous waste includes nuclear waste.

In another aspect combinable with any of the previous aspects of the third example implementation, the at least one of the first or second subterranean formations are under a body of water.

In a fourth example implementation, a method for managing hazardous waste includes moving one or more hazardous waste canisters that enclose hazardous waste into a substantially vertical access drillhole portion formed from a terranean surface into a first subterranean formation having relatively high tectonic activity; moving the one or more hazardous waste canisters from the substantially vertical access drillhole portion into a curved portion that is at least partially formed in the first subterranean formation; and moving the one or more hazardous waste canisters from the curved portion into a storage region of a substantially horizontal drillhole portion coupled to the curved portion and formed in a second subterranean formation having relatively low tectonic activity compared to the first subterranean formation. The substantially vertical access drillhole portion and the curved portion are free of the one or more hazardous waste canisters.

In an aspect combinable with the fourth example implementation, the first subterranean formation includes a sedimentary rock formation.

In another aspect combinable with any of the previous aspects of the fourth example implementation, the second subterranean formation includes a crystalline basement rock formation.

Another aspect combinable with any of the previous aspects of the fourth example implementation further includes re-drilling at least one of the substantially vertical access drillhole portion or the curved portion in response to a distortion or collapse caused by tectonic or seismic activity.

In another aspect combinable with any of the previous aspects of the fourth example implementation, the substantially horizontal drillhole portion includes a first part coupled to the curved portion and a second part coupled to the first part that includes the storage region.

In another aspect combinable with any of the previous aspects of the fourth example implementation, the first part of the substantially horizontal drillhole portion is formed at least partially in the first subterranean formation.

In another aspect combinable with any of the previous aspects of the fourth example implementation, the first part of the substantially horizontal drillhole portion is free of the one or more hazardous waste canisters.

In another aspect combinable with any of the previous aspects of the fourth example implementation, the first part of the substantially horizontal drillhole portion includes a length configured for a free-falling hazardous waste canister to come to a stop without hitting the one or more hazardous waste canisters in the storage region.

In another aspect combinable with any of the previous aspects of the fourth example implementation, the hazardous waste includes nuclear waste.

In another aspect combinable with any of the previous aspects of the fourth example implementation, the at least one of the first or second subterranean formations are under a body of water.

Another aspect combinable with any of the previous aspects of the fourth example implementation further includes retrieving at least one of the one or more hazardous waste canister from the storage region to the terranean surface based at least in part on a distortion or collapse of at least one of the substantially vertical access drillhole portion or the curved portion caused by tectonic or seismic activity.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A hazardous waste repository, comprising:
a directional drillhole formed from a terranean surface into a subterranean formation, the directional drillhole comprising:
an access drillhole portion that comprises an entry at the terranean surface sized to receive one or more hazardous waste canisters configured to enclose hazardous waste,
a curved drillhole portion coupled to the access drillhole portion, and
a substantially horizontal or inclined drillhole portion coupled to the curved drillhole portion, the substantially horizontal or inclined drillhole portion comprising a storage region sized and configured to store the one or more hazardous waste canisters; and
a flow conduit formed or installed from the terranean surface into the subterranean formation and in fluid communication with the storage region, the flow conduit and the directional drillhole configured to receive a flow of a liquid that circulates from the terranean surface, through the flow conduit and the storage region, and back to the terranean surface for a corrosion analysis of the liquid.

2. The hazardous waste repository of claim 1, wherein the flow conduit and the directional drillhole are configured to receive the flow of the liquid that circulates from the terranean surface, through the flow conduit, into the storage region from the flow conduit, and back to the terranean surface from the storage region for the corrosion analysis of the liquid.

3. The hazardous waste repository of claim 1, wherein the corrosion analysis of the liquid comprises an analysis of one or more metallic particles within the liquid from one or both of a casing installed in the directional drillhole or the one or more hazardous waste canisters.

4. The hazardous waste repository of claim 3, wherein the corrosion analysis of the liquid comprises an analysis of an origin of the one or more metallic particles based on a type of metal of the one or more metallic particles.

5. The hazardous waste repository of claim 1, wherein the flow conduit comprises a borehole formed from the terranean surface into the subterranean formation to intersect the directional drillhole.

6. The hazardous waste repository of claim 5, wherein the borehole comprises a substantially vertical borehole.

7. The hazardous waste repository of claim 5, wherein the borehole comprises a slant or directional borehole.

8. The hazardous waste repository of claim 5, wherein a diameter of the borehole is smaller than a diameter of the storage region.

9. The hazardous waste repository of claim 5, wherein the borehole intersects the storage region.

10. The hazardous waste repository of claim 1, wherein the flow conduit comprises a pilot hole that extends from the directional drillhole and comprises an opening at the terranean surface separate from the entry.

11. The hazardous waste repository of claim 10, wherein the pilot hole comprises a diameter that is the same as or substantially similar to a diameter of the storage region.

12. The hazardous waste repository of claim 10, wherein the pilot hole comprises another storage region sized and configured to store another one or more hazardous waste canisters.

13. The hazardous waste repository of claim 1, wherein the flow conduit comprises a catheter installed on or in the casing, the catheter comprising a hollow tube having a first open end at or near the terranean surface and a second open end in the directional drillhole.

14. The hazardous waste repository of claim 13, wherein the second open end is positioned in the storage region.

15. The hazardous waste repository of claim 13, wherein the hollow tube is attached to an exterior surface of the casing.

16. The hazardous waste repository of claim 13, wherein the catheter is installed on or in the casing prior to installation of the casing in the directional drillhole.

17. The hazardous waste repository of claim 1, wherein the hazardous waste comprises nuclear waste.

18. A method for monitoring hazardous waste in a hazardous waste repository, comprising:
identifying a directional drillhole formed from a terranean surface into a subterranean formation, the directional drillhole comprising an access drillhole portion that comprises an entry at the terranean surface, a curved drillhole portion coupled to the access drillhole portion, and a substantially horizontal or inclined drillhole portion coupled to the curved drillhole portion that comprises a storage region that stores one or more hazardous waste canisters configured to enclose hazardous waste; and
identifying a flow conduit formed or installed from the terranean surface into the subterranean formation and in fluid communication with the storage region, where the flow conduit and the directional drillhole form a liquid flow path to and from the terranean surface;
circulating a liquid from the terranean surface, through the liquid flow path, and back to the terranean surface; and
performing a corrosion analysis of the liquid circulated back to the terranean surface from the liquid flow path.

19. The method of claim 18, wherein circulating the liquid from the terranean surface, through the liquid flow path, and back to the terranean surface comprises:
flowing the liquid from the terranean surface, through the flow conduit, into the storage region from the flow conduit, and back to the terranean surface from the storage region.

20. The method of claim 18, wherein performing the corrosion analysis comprises:
performing the corrosion analysis of one or more metallic particles within the liquid from one or both of a casing installed in the directional drillhole or the one or more hazardous waste canisters.

21. The method of claim 20, wherein the corrosion analysis of the liquid comprises an analysis of an origin of the one or more metallic particles based on a type of metal of the one or more metallic particles.

22. The method of claim 18, wherein the flow conduit comprises a borehole formed from the terranean surface into the subterranean formation to intersect the directional drillhole.

23. The method of claim 22, wherein the borehole comprises a substantially vertical borehole.

24. The method of claim 22, wherein the borehole comprises a slant or directional borehole.

25. The method of claim 22, wherein a diameter of the borehole is smaller than a diameter of the storage region.

26. The method of claim 22, wherein the borehole intersects the storage region.

27. The method of claim 18, wherein the flow conduit comprises a pilot hole that extends from the directional drillhole and comprises an opening at the terranean surface separate from the entry.

28. The method of claim 27, wherein the pilot hole comprises a diameter that is the same as or substantially similar to a diameter of the storage region.

29. The method of claim 27, wherein the pilot hole comprises another storage region sized and configured to store another one or more hazardous waste canisters.

30. The method of claim 18, wherein the flow conduit comprises a catheter installed on or in the casing, the catheter comprising a hollow tube having a first open end at or near the terranean surface and a second open end in the directional drillhole.

31. The method of claim 30, wherein the second open end is positioned in the storage region.

32. The method of claim 30, wherein the hollow tube is attached to an exterior surface of the casing.

33. The method of claim 30, wherein the catheter is installed on or in the casing prior to installation of the casing in the directional drillhole.

34. The method of claim 18, wherein the hazardous waste comprises nuclear waste.
